(19) United States
(12) Patent Application Publication
(10) Pub. No.: US 2026/0321837 A1
(43) Pub. Date: Oct. 15, 2026

(54) FLEXIBLE ULTRA-LARGE CAST BATTERY FRAME

(71) Applicant: MAGNA INTERNATIONAL INC., Aurora (CA)

(72) Inventor: Thomas RICHTER, Troy, MI (US)

(21) Appl. No.: 19/639,435

(22) Filed: Apr. 6, 2026

Related U.S. Application Data
(60) Provisional application No. 63/786,609, filed on Apr. 10, 2025.

(51) Int. Cl. H01M 50/238; H01M 50/249; H01M 50/258

(52) U.S. Cl. CPC H01M 50/238; H01M 50/249; H01M 50/258

(57) ABSTRACT

An ultra-large cast battery frame includes a plurality of integrally cast battery module bays that are scalable from the initial ultra-large cast battery frame to form a plurality of differently and smaller sized cast battery frame geometries. Put another way, a method of manufacturing a battery frame includes initially casting an ultra-large integral cast battery frame having a plurality of integrally cast battery module bays. At least one of the integrally cast battery module bays can then be split or cut away from the initial ultra-large cast battery frame to scale-down and form a smaller cast battery frame geometry. The smaller cast battery frame geometry has less integrally cast battery modules than initially present in the ultra-large cast battery frame, and thus provides a flexible manufacturing design that can be easily adapted and scaled to accommodate multiple types of differently sized battery frames.

### CROSS-REFERENCE TO RELATED APPLICATION

The subject application claims priority to and the benefit of U.S. Provisional Application Serial No. 63/786,609 filed on Apr. 10, 2025, the entire disclosure of which is incorporated herein by reference.

### BACKGROUND OF THE INVENTION

### 1. Field of the Invention

The present invention relates to a battery frame and a method of manufacturing same.

### 2. Related Art

This section provides background information related to the present disclosure which is not necessarily prior art.

Automobiles are the subject of a continuing effort to move away from internal combustion engines towards electrified vehicles, to reduce their dependency on fuel, improve emissions and increase fuel efficiency. Thus, this desire to increase fuel efficiency is both economically and environmentally motivated and has led to advanced internal components in automobiles as evidenced by developments in batteries, particularly in electrified vehicles. Unlike traditional automobiles that operate entirely with fossil fuels, electrified vehicles include a range of technologies that rely on electric energy. Even though electric energy is a more economical and environmentally friendly option over relying completely on fossil fuels, batteries are heavy, expensive, and relatively fragile compared to neighboring mechanical components. As such, the packaging of batteries, particularly within electrified vehicles, requires a number of design considerations including weight distribution, temperature regulation, and serviceability. In terms of serviceability, there is a growing need, particularly with electrified vehicles, for the batteries to be stowed in such a manner to be charged and maintained without removal.

To meet the above minimum requirements, batteries have traditionally been packaged in protective battery frames, which in some cases are formed from a welded construction of various aluminum extrusions or in some other cases are formed as an integrally cast design. However, in either arrangement, battery frames are initially configured and specifically tailored to a large array of sizes depending on the type of electric vehicle (e.g., battery electric vehicle (BEV), plug-in electric vehicle (PHEV), hybrid electric vehicle (HEV), etc.) in which the battery frame is to be implemented. Put another way, traditional battery frames are designed for specific use with one type of electric vehicle are thus not readily suitable for use with another type of electric vehicle given the significant size differences. And since the volumes of electric vehicles are presently dynamic across all of the various EV types, this highly variable volume creates a lot of manpower, capital and profitability problems for manufacturers of battery frames, namely because the specific needs for each size of battery frame are difficult to forecast. Furthermore, continued development of other battery chemistries (e.g., solid state batteries, sodium batteries, lithium sulfur batteries, and the like) are likely to have a future impact on the associated size of the battery frame for use with any type of electric vehicle.

Accordingly, there remains a continuing need for improved battery frame designs which eliminate their initial reliance on the specific electric vehicle type, and thus provide a more flexible, manufacturing design available for use across all electric vehicle types.

### SUMMARY OF THE DISCLOSURE

In accordance with a first aspect, the subject disclosure is directed to an ultra-large one-piece cast battery frame including a plurality of integrally cast battery module bays being scalable (e.g., “splittable”) from the initial ultra-large cast battery frame to form a plurality of differently and smaller sized cast battery frame geometries. Put another way, a method of manufacturing a battery frame includes initially castingthe ultra-large integral cast battery frame having the plurality of integrally cast battery module bays. At least one of the integrally cast battery module bays can then be split or cut away from the initial ultra-large cast battery frame, either individually or in association with a plurality of other ones of the integrally battery module bays, to scale-down and form a smaller cast battery frame geometry having less integrally cast battery modules than initially present in the ultra-large cast battery frame. Thus, the method of manufacturing the smaller cast battery frame geometries from the initial ultra-large cast battery frame provides a flexible manufacturing design that can be easily adapted and scaled to accommodate multiple types of differently sized battery frames, such as may be needed for a variety of different EV platforms (e.g., battery electric vehicle (BEV), plug-in electric vehicle (PHEV), hybrid electric vehicle (HEV). In other words, the ultra-large cast battery frame provides a flexible design that allows cast battery frames of multiple different sizes to be manufactured using a single die cast machine and die casting die. Accordingly, the integral ultra-large cast battery frame can be easily scaled by manufacturers to the requisite size for the battery frame depending on the intended application, and/or as volumes of EV types and/or related battery technologies emerge and develop in real-time.

In accordance with a second aspect of the subject disclosure, the method of manufacturing the battery frame can include forming an initial casting having a plurality of individual and separately cast battery module bays. The method can then proceed by splitting or cutting away the plurality of individual and separately cast battery module bays away from the initial casting, and then joining together certain ones of the split or cut away battery module bays via a connection to collectively form the battery frame geometry.

In accordance with a third aspect of the subject disclosure, the method of manufacturing the battery frame can include forming an initial casting having integrally cast pairs of battery module bays which are each cast separately from other integrally cast pairs of battery module bays. The method can then proceed by splitting or cutting away the integrally cast pairs of battery module bays from the initial casting and then joining together certain pairs of split or cut away battery module bays to collectively form the battery frame geometry.

Each of the second and third embodiments also provides a flexible manufacturing design that allows cast battery frames of multiple different sizes to be manufactured using a single die cast machine and die casting die. Accordingly, each of the initial castings in the second and third embodiments can also be easily scaled by manufacturers to the requisite size for the battery frame depending on the intended application.

### BRIEF DESCRIPTION OF THE DRAWINGS

These and other advantages of the present disclosure will be more readily understood by reference to the following description in combination with the accompanying drawings wherein:

FIG. 1 is a perspective view of an exemplary battery housing including a battery frame enclosed by a top cover and a bottom tray to collectively house at least one battery for an electric vehicle;

FIG. 2 is a top view of a one-piece, ultra-large cast battery frame including a plurality of integrally cast battery module bays in accordance with a first embodiment of the subject disclosure;

FIG. 3A is a top view of the one-piece, ultra-large cast battery frame being initially formed with a pre-determined number of integrally cast battery module bays, in accordance with an aspect of the disclosure;

FIG. 3B is a top view of a first battery frame geometry that is split or scaled down from the initial one-piece, ultra large cast battery frame of FIG. 3A, in accordance with an aspect of the disclosure;

FIG. 3C illustrates top views of second and third battery frame geometries that can be split or scaled down from the initial one-piece, ultra large cast battery frame of FIG. 3A, in accordance with another aspect of the disclosure;

FIG. 3D illustrates top views of fourth, fifth and sixth battery frame geometries that can be split or scaled down from the initial one-piece, ultra large cast battery frame of FIG. 3A, in accordance with another aspect of the disclosure;

FIG. 4 is a flow chart more clearly illustrating the initial one-piece, ultra-large cast battery frame being split or scaled down into a plurality of different and smaller cast battery frame geometries to demonstrate manufacturing flexibility provided by the initial one-piece, ultra-large cast battery frame;

FIG. 5 illustrates various top views of a plurality of battery frame geometries capable of being scaled down and manufactured from the one-piece, ultra-large cast battery frame to more clearly illustrate certain ones of the integrally cast battery module bays being split away from the one-piece, ultra-large cast battery frame to manufacture the various smaller cast battery frame geometries;

FIG. 6 illustrates various top views of the one-piece ultra-large cast battery frame having certain ones of the plurality of battery module bays being split or cut-away to eliminate associated defects in the respective defective battery module bays, and then illustrating the remaining plurality of battery module bays being re-purposed for other smaller cast battery frame geometries to effectively reduce scrap for the initial one-piece ultra-large battery frame;

FIG. 7A is a top view of a second embodiment of the subject disclosure in which an initial casting includes a plurality of individual and separately cast battery module bays;

FIG. 7B is a top view illustrating the plurality of individual and separately cast battery module bays being split or cut away from the initial casting and then joined together via a connection to collectively form the battery frame geometry in accordance with the second embodiment;

FIG. 8A is a top view of a third embodiment of the subject disclosure in which the initial casting includes integrally cast pairs of battery module bays which are each cast separately from other integrally cast pairs of battery module bays; and

FIG. 8B is a top view illustrating the integrally cast pairs of battery module bays being split or cut away from the initial casting and then joined together with other split or cut away integrally cast pairs of battery modules to collectively form the battery frame geometry in accordance with the third embodiment.

### DETAILED DESCRIPTION OF THE ENABLING EMBODIMENTS

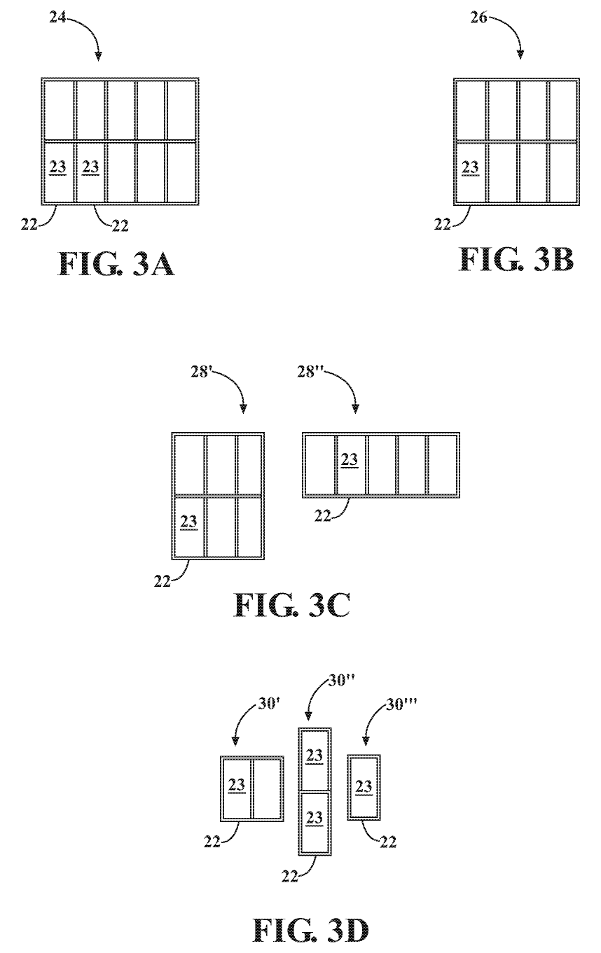

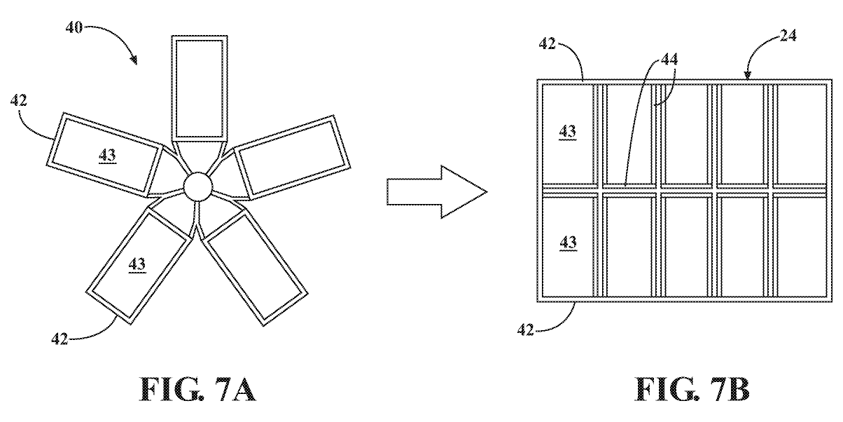

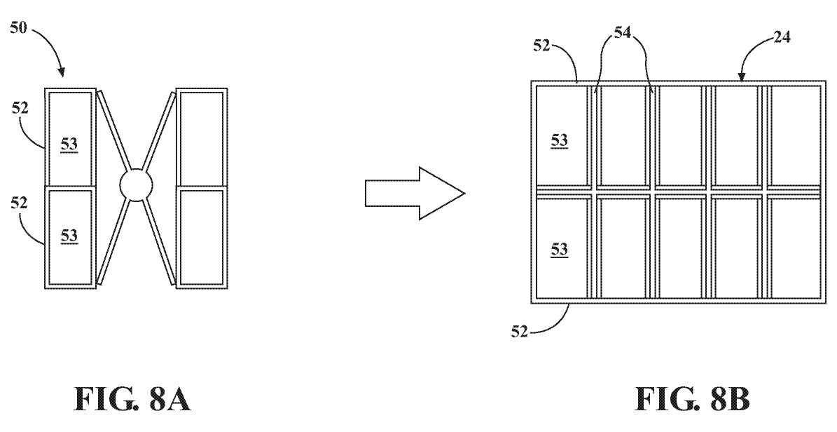

Example embodiments will now be described more fully with reference to the accompanying drawings. In general, the subject disclosure is directed to an integral ultra-large cast battery frame 20 and a method of manufacturing a smaller battery frame geometry 26, 28, 30 from same (See e.g., FIGS. 3B-5), namely by scaling-down or splitting at least one (and in some cases a plurality) of integrally cast battery module bays 22 from the integral ultra-large cast battery frame 20 to create alternate and smaller cast battery frame geometries 26, 28, 30 tailored to the specific type of intended use, e.g., for an electric vehicle. However, the example embodiments are only provided so that this disclosure will be thorough, and will fully convey the scope to those who are skilled in the art. To this end, the method of manufacturing the battery frame from the ultra-large cast battery frame can be applied to any implementation which requires a battery frame – i.e., not one limited to use with just electric vehicles. Furthermore, numerous specific details are set forth such as examples of specific components, devices, and methods, to provide a thorough understanding of embodiments of the present disclosure. It will be apparent to those skilled in the art that specific details need not be employed, and that example embodiments may be embodied in many different forms (e.g., instead of starting from the ultra-large cast battery frame 20, individual and separate battery module bays 42 or integrally cast pairs of battery module bays 52 can also be initially formed and then collectively joined after being split to form the alternate battery frame geometries – See FIGS. 7A-8B). However, each of these three embodiments should not be limiting to the subject disclosure, and in some example embodiments, well-known processes, well-known device structures, and well-known technologies are not described in detail.

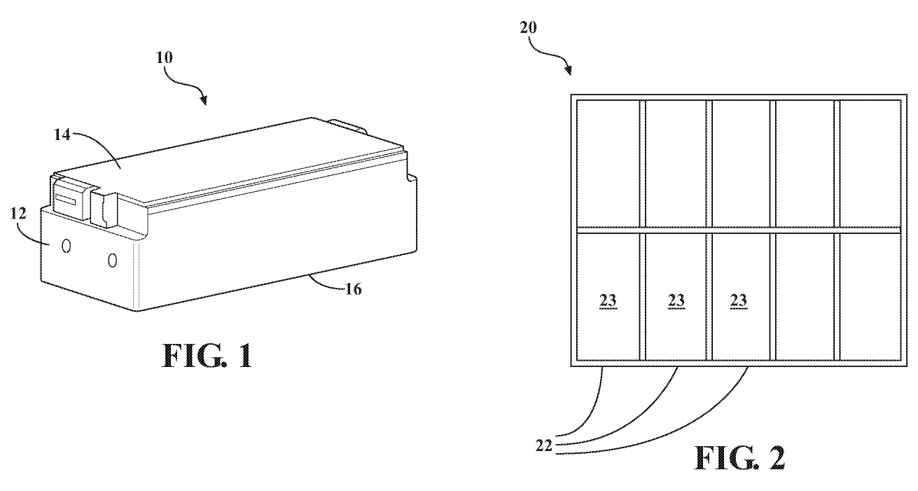

As illustrated in FIG. 1, an exemplary battery housing 10 in accordance with certain prior art aspects can include a battery frame 12 that is enclosed by a top cover 14 and a bottom tray 16 to collectively house at least one battery, such as for use with an electric vehicle (EV). However, as mentioned in the background sections, the prior art battery frames 12 are initially configured and tailored specific to their specific use (e.g., the type of electric vehicle in which they are intended for use). Put another way, traditional battery frames are typically designed for use with one specific implementation, e.g., the type of electric vehicle, and not readily suitable for use with another implementation, e.g., another type of electric vehicle, given the size differences.

As best illustrated in FIGS. 2-5, in a first embodiment of the subject disclosure, the prior art battery frames 12 are replaced by a battery frame geometry formed or scaled from an ultra-large cast battery frame 20 initially cast to include a plurality of integrally cast battery module bays 22 each defining a cavity 23 for housing at least one battery. Put another way, the subject method of manufacturing the desired battery frame geometry includes initially casting an integral, ultra-large cast battery frame 20 having a plurality of integrally cast battery module bays 22 (See FIGS. 2-3A), and then splitting or cutting away certain of the battery module bays 22 from the initial casting to create alternate and smaller cast battery frame geometries 26, 28, 30 (See FIGS. 3B-5), depending on the intended implementation for the battery frame geometry, e.g., the type of electric vehicle intended for commensurate use. As will be appreciated in view of the following more detailed description, the initial ultra-large cast battery frame 20 including a plurality of integrally cast battery module bays 22 provides a flexible design that can be easily adapted and scaled down to accommodate multiple different smaller sizes of cast battery frames 26, 28, 30, such as for use with multiple types of EV platforms.

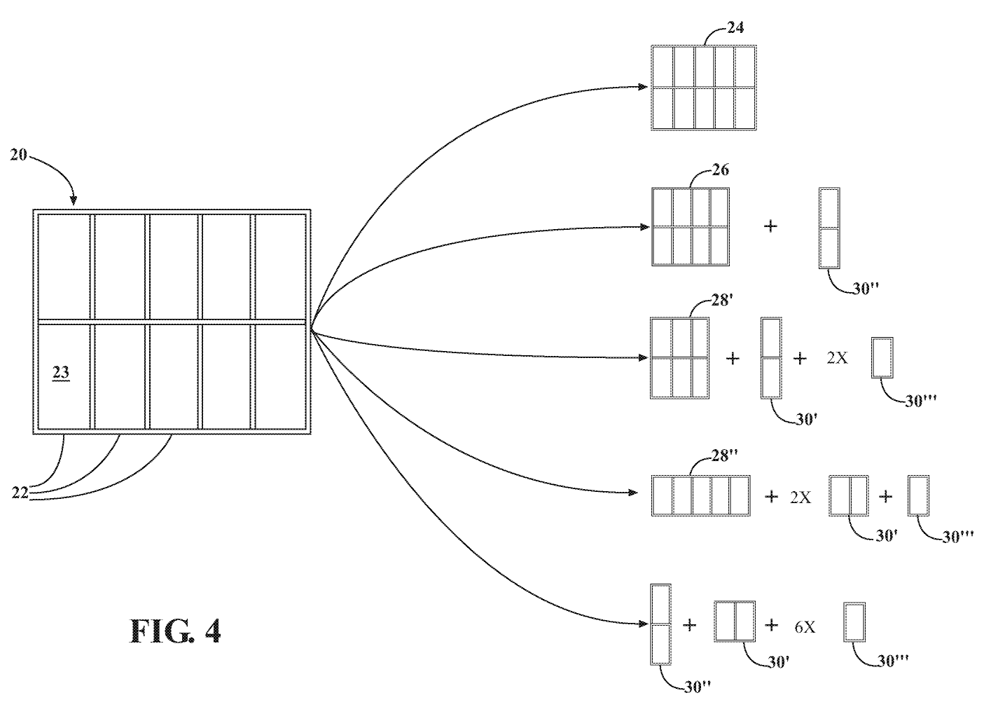

For example, as best shown in FIGS. 3A and 4, the initial casting for the ultra-large cast battery frame 20 can be configured to include a pre-determined number of (e.g., ten) integrally cast battery module bays 22 to form an initial sized geometry 24, such as may be designed to accommodate an extended pack battery frame geometry 24 for use with an extended range EV type. Thus, the subject design and related method of manufacturing in accordance with an embodiment can be designed using a die cast machine to create a single, ultra-large cast battery frame 20 which satisfies, as initially cast, the sizing for an extended range EV.

As illustrated in FIGS. 3B-3D, 4, and 5, the design of this ultra-large cast battery frame 20 is then scalable and splittable, meaning that the initially shaped battery frame geometry 24 can have certain of the integrally cast battery module bays 22 cut or split away, such as via fiber laser cutting, saw cutting, or the like, to create a subsequent scaled-down and smaller cast battery frame geometry 26, 28, 30 that can be used as an alternative battery frame for use with other implementations. Each of the battery module bays 22 which remain in the scaled-down battery frame geometries are still integrally cast with one another, and thus the scaling and splitting of the ultra-large cast battery frame 20 still results in an integrally cast battery frame – just of smaller size.

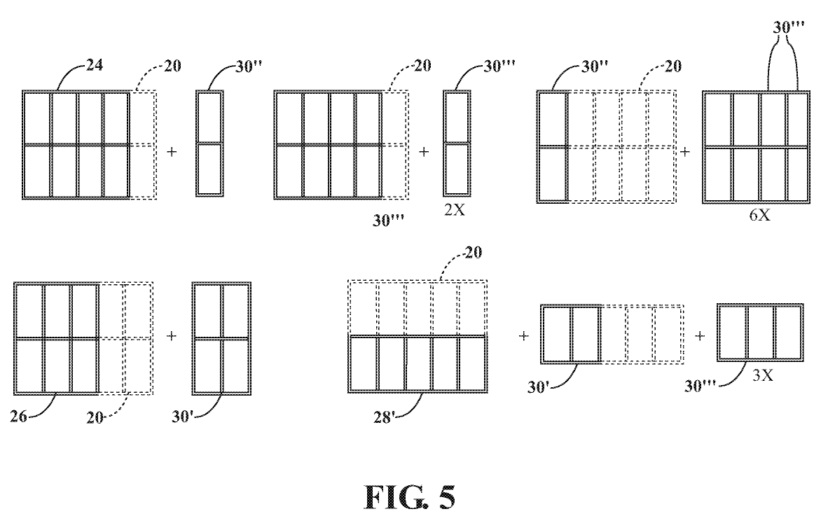

For example, as shown in FIG. 3B, two of the integrally cast battery module bays 22 may be split or cut away from the initial ultra-large cast battery frame 20 to form a first scaled-down and smaller cast battery frame geometry 26 having a reduced number of (e.g. eight) integrally cast battery module bays 22, such as may be sized to accommodate a standard pack battery frame geometry. Additionally, as shown in FIG. 3C, in another example four or five of the integrally cast battery module bays 22 may be split or cut away from the initial ultra-large cast battery frame to form a second and third smaller frame geometries 28’, 28’’ having six and five integrally cast battery module bays 22, respectively, such as may be sized to accommodate a short or narrow battery frame geometry for an EV. In yet another example, as shown in FIG. 3D, one or two of the integrally cast battery modules 22 may be split or cut away from the initial ultra-large cast battery frame 20 to form fourth, fifth and sixth smaller cast battery frame geometries 30’, 30’’, 30’’’, such as may be sized to accommodate a PHEV or HEV battery frame geometry. In each example, the smaller cast battery frame geometries 26, 28, 30 each have a reduced number of battery module bays 22 than the initial ultra-large cast battery frame 20, and can be created, depending on the intended battery frame implementation, and any related battery chemistry for the battery frame. (See also FIGS. 4-5, which illustrate other potential design splits and final products which can be produced from the ultra-large cast battery frame 20). Thus, the splittable and scalable design for the ultra-large cast battery frame 20 provides increased production flexibility, namely via the ability to meet the demand of multiple battery frame configurations, of different battery specifications all from the use of one casting die and one die cast machine.

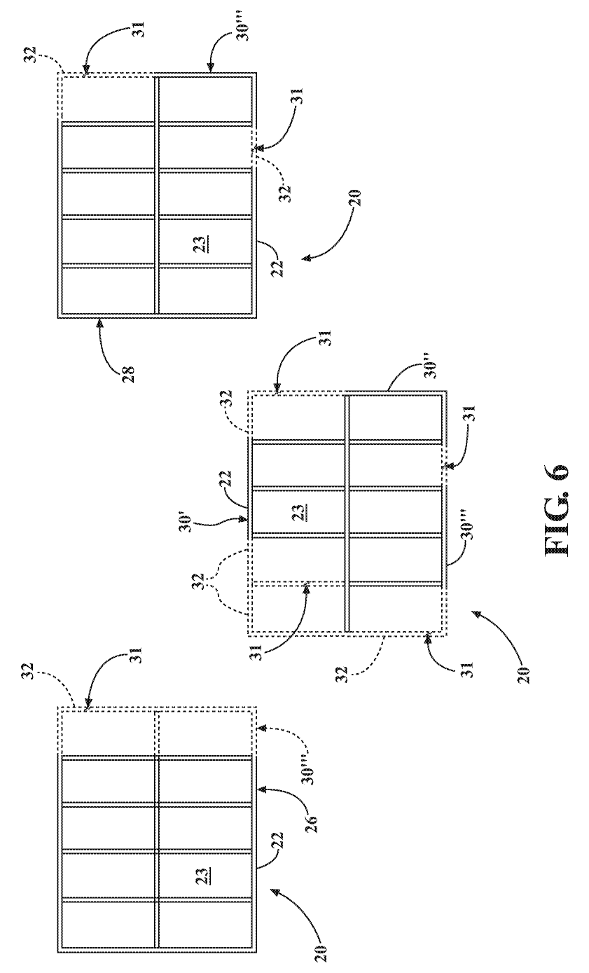

As illustrated in FIG. 6, the ultra-large cast battery frame 10 also provides for the ability to reduce a scrap rate relative to prior art methods of manufacturing (e.g., casting) battery frames, namely because only defective segments of the ultra-large cast battery frame 10 need to be scrapped and remelted, as opposed to scraping the entire casting, as would be the case in the traditional manufacturing methods. More specifically, in the case where the integral ultra-large cast battery frame 10 includes a defect 31 in at least one defective battery module bay 32 of the plurality of battery module bays 22, this at least one defective battery module bay 32 can be split or cut-away from the ultra-large cast battery frame 10, leaving the remaining plurality of battery module bays 22 to be split and utilized for full value in the smaller battery frame geometries. Thus, the ultra-large cast battery frame 10 reduces manufacturing scrap, namely because the only scrap generated from the subject manufacturing method comes from the defective battery module bays 32 as opposed to scrapping the entire cast frame (inclusive of the non-defective battery module bays 22 from the subject design), as would be required in the prior art manufacturing methods. This advantage means that, even with a 10-20% casting defect rate, the scrap rate will be far lower as it is often only small, local areas of the casting that are defective (See e.g., the defects 31 in FIG. 6), which in the subject disclosure can be split off via the defective battery bay(s) 32 to recover and save material for the remaining battery module bays 22 which remain in good and usable condition. As a result, the subject design and related manufacturing method also saves a large amount of raw material (e.g., aluminum), which leads to reduced emissions for material purchasing.

Although not expressly illustrated in the Figures, it is envisioned that the following design features could be included and incorporated into the ultra-large cast battery frame 20:
Die castability in a 4400T press
Flexible mounting points for all battery frame geometries to connect multiple different vehicle architectures and configurations
Top and bottom features on outer perimeter and on each segment for top and bottom cover plate mounting
Wide enough cross rails to allow for segment cutting while maintaining ability to seal each segment by joining a top and bottom cover
Ability to add I/O ports for data and power to each segment
Mounting points for battery modules and power electronics
Sizing, weight, and form factor to enable attachment to multiple classes of vehicle, multiple battery chemistries and multiple drivetrain configurations

As best illustrated in FIGS. 7A-7B, in accordance with a second embodiment of the subject disclosure, an initial casting 40 can include a plurality of individual and separately cast battery module bays 42 each defining a respective cavity 43 for housing at least one battery and which are split or cut away and then joined together via a connection 44 (e.g., a friction weld or the like) to collectively form the intended battery frame geometry 24. For example, as illustrated in FIG. 7A, the casting die and die cast machine can be used to cast a pre-determined amount (e.g., five) separate battery module bays 42 which can each individually split away and then be selectively joined together via connections 44 to form the battery frame geometry 24, or the like. Thus, in contradistinction to the ultra-large cast battery frame 20 which is subtractive of the battery module bays 22 to form the intended battery frame geometry, this alternative manufacturing design is additive to form the intended battery frame geometry.

As illustrated in FIGS. 8A, in accordance with a third embodiment of the subject disclosure, the casting die and die cast machine can be used to form an initially casting 50 which includes integrally cast pairs of battery module bays 52 which are each cast separately from other integrally cast pairs of battery module bays 52. Similar to the other embodiments, each battery module bay 52 in the integrally cast pairs of battery module bays 52 defines a cavity 53 for housing at least one battery. As illustrated in FIG. 8B, the integrally cast pairs of battery module bays 52 can then be split or cut away from the initial casting 50 and joined together with other split or cut away integrally cast pairs of battery modules 52 via a connection 54 (e.g., a friction weld or the like) to collectively form the battery frame geometry 54, or the like. Similar to the second embodiment, this third manufacturing method is also additive to form the intended battery frame geometry.

Obviously, many modifications and variations of the present disclosure are possible in light of the above teachings and may be practiced otherwise than as specifically described.

What is claimed is:

1. A method of manufacturing a battery frame, the method comprising:
initially casting an ultra-large cast battery frame having a plurality of integrally cast battery module bays, and
splitting away at least one of the integrally cast battery module bays from the ultra-large cast battery frame to form a smaller cast battery frame geometry.

2. The method as set forth in claim 1, wherein the splitting away step includes splitting away a plurality of the integrally cast battery module bays to form the smaller cast battery frame geometry.

3. The method as set forth in claim 1, wherein the ultra-large cast battery frame includes a defect in at least one defective battery module bay of the plurality of battery module bays, and the step of splitting away includes splitting away the at least one defective battery module bay from the ultra-large cast battery frame.

4. The method as set forth in claim 1, wherein each of the plurality of integrally cast battery module bays define a cavity for housing at least one battery.

5. The method as set forth in claim 1, wherein the splitting away step includes splitting away at least one of the integrally cast battery module bays via fiber laser cutting.

6. The method as set forth in claim 1, wherein the splitting away step includes splitting away at least one of the integrally cast battery module bays via saw cutting.

7. The method as set forth in claim 1, wherein the smaller cast battery frame geometry is for use with an electric vehicle.

8. A method of manufacturing a battery frame, comprising:
forming an initial casting having a plurality of individual and separately cast battery module bays;
splitting away the plurality of individual and separately cast battery module bays away from the initial casting, and
joining together certain ones of the split battery module bays via a connection to collectively form a battery frame geometry.

9. The method as set forth in claim 8, wherein the connection is a friction stir weld.

10. The method as set forth in claim 8, wherein the battery frame geometry is for use with an electric vehicle.

11. The method as set forth in claim 8, wherein each of the individual and separately cast battery module bays defines a cavity for housing at least one battery.

12. A method of manufacturing a battery frame, comprising:
forming an initial casting having a plurality of integrally cast pairs of battery module bays;
splitting away the integrally cast pairs of battery module bays from the initial casting; and
joining together certain ones of the split away integrally cast pairs of battery module bays via a connection to collectively form a battery frame geometry.

13. The method as set forth in claim 12, wherein each integrally cast pair of battery module bays are cast separately from other integrally cast pairs of battery module bays.

14. The method as set forth in claim 12, wherein the connection is a friction stir weld.

15. The method as set forth in claim 8, wherein the battery frame geometry is for use with an electric vehicle.
